(19) United States
(12) Patent Application Publication
(10) Pub. No.: US 2007/0170710 A1
(43) Pub. Date: Jul. 26, 2007

(54) Venting systems for inflatable objects

(76) Inventor: Benoit Bouquier, Villeurbanne (FR)

Correspondence Address: JOHN S. PRATT, ESQ;KILPATRICK STOCKTON, LLP, 1100 PEACHTREE STREET, ATLANTA, GA, 30309, US

(21) Appl. No.: 11/338,322

(22) Filed: Jan. 24, 2006

(51) Int. Cl. B60R 21/239

(52) U.S. Cl. 280/739; 280/743.1

(57) ABSTRACT

Systems for inflating, and venting inflation gas from, objects are detailed. The systems are especially, although not necessarily, adapted for use with vehicle air bags and allow varying amounts of gas to be evacuated from the bags. The bags may include at least one vent hole through their walls and need only one closure band or membrane per hole.

### FIELD OF THE INVENTION

This invention relates to vents for inflatable objects and more particularly, but not exclusively, to venting systems for inflatable bags typically used in vehicles including, but not limited to, automobiles.

### BACKGROUND OF THE INVENTION

Protecting occupants of vehicles during crashes has long been a concern of vehicle manufacturers and others involved in vehicle safety programs. This concern has resulted in development of, among other devices, inflatable air bags for placement within vehicles. Such air bags are normally deflated; however, when certain crashes or other impacts are sensed, the bags may be inflated rapidly to decelerate the occupants and, in some cases, prevent them from contacting rigid objects within their corresponding vehicles.

Because crash severities and occupant masses may differ significantly from event to event, multi-stage inflation systems have been designed for air bags. In these systems, varying amounts of air or other gas may be used to inflate the bags based on such criteria as the deceleration value of the vehicle, the weight of the affected occupant, and the position of the occupant's seat within the vehicle. U.S. Pat. No. 5,871,231 to Richards, et al. (the “Richards Patent”) details exemplary multi-stage inflation systems, disclosing
an air bag with releasable partitioning, preferably breakaway stitching, that provides a variable-size inflatable volume and . . . a means to control the level of inflation. These features . . . provide optimum protection regardless of whether the occupant is restrained by a seat belt and regardless of whether the crash speed at impact is moderate or severe.
   See Richards Patent, Abstract, 11. 3-9. At least some other multi-stage systems are relatively expensive, as multiple-stage gas generators and multiple electrical signal cables are required. Some existing multi-stage systems also are larger and heavier than conventional single-stage systems.

Because in some situations inflation gas must be vented from the bags, the bags may be equipped with one or more vents. As an example, the Richards Patent discloses multiple vent holes located on a rear panel of the bag. Other systems may employ external valves for venting. Generally, however, external valves inadequately accommodate occupants seated close to the bags unless additional sensors are employed.

International Patent Publication No. WO 2005/037613 of Bradburn, et al. (the “Bradburn Publication”) discloses an inflatable air bag for a motor vehicle. Separately attached to the air bag are inner (elastic) and outer membranes, the former of which includes a vent hole. When the vent hole is spaced from the outer membrane, air may exit the air bag via the hole. By contrast, when pressure within the air bag exceeds a threshold value, the inner membrane seals against a portion of the outer membrane (designated the “pucker”), thereby covering the hole and preventing (further) venting.

Multiple issues exist with vent mechanisms such as those described in the Bradburn Publication. Adding the separate inner and outer membranes to the bag may increase effort and cost needed to manufacture the bag, for example. Moreover, having the vent hole in the inner (elastic) membrane tends to equalize pressure on both sides of the membrane, inhibiting it from stretching and sealing against the pucker of the outer membrane. Consequently, not only may systems such as that of the Bradburn Publication be more expensive and difficult to produce, they may be harder to control as well.

### SUMMARY OF THE INVENTION

The present invention provides inflation systems differing from those discussed in the preceding section. Bags of the present systems may use single-stage gas generators for inflation and may themselves be single volume, but unlike many prior systems allow for variable gas evacuation. Unlike the Bradburn Publication, moreover, they need not have any second, outer membrane and are not subject to the problems described above associated with pressure equalization.

Instead, bags of the present invention include at least one vent hole through their linings or walls. They additionally include an elastic band or membrane linked to the interior surface of the bags in areas to sides of the hole. The band preferably is linked to the interior surface so as to form a “fold,” or relaxed area, adjacent the hole, which fold spaces the hole from the band and thereby allows gas to flow through the hole.

During a low-energy vehicle impact, lining tension of the bag remains relatively weak. This weakness does not substantially stretch the bag wall or elongate the elastic band, thus causing the fold to remain intact. Continued existence of the fold allows gas to flow by the band and through the hole, thereby venting the bag.

For higher-energy vehicle impacts, as a vehicle occupant contacts the inflating bag, this contact will increase the internal bag pressure and create an increase in tension of the bag wall. The increased tension in turn elongates the elastic band and diminishes the fold, bringing the hole against the band and thereby sealing it. Clear from this description is that impact of intermediate energies create intermediate tension increases, progressively closing the hole and varying the amount of gas able to be vented thereby.

Elastic bands of the present invention preferably are made of silicone or rubber. Alternatively, the bands need not necessarily be elastic, but may, instead, be equipped with fusible or other elements extendable when appropriately tensioned. The bands also may be made of fabric with expanded area. Further, more than one vent hole and band may be used for a particular bag if necessary or desired.

It thus is an optional, non-exclusive object of the present invention to provide venting systems for inflatable objects.

It is an additional optional, non-exclusive object of the present invention to provide single-volume bags and single-stage gas generators yet nevertheless inflate the bags to varying volumes.

It is a further optional, non-exclusive object of the present invention to provide venting systems having variable gas evacuation.

It is also an optional, non-exclusive object of the present invention to provide venting systems that, for each vent, need utilize only a single band or membrane.

It is, moreover, an optional, non-exclusive object of the present invention to provide venting systems having folds, or relaxed areas, in the walls of the inflatable bags.

Other objects, features, and advantages of the present invention will be apparent to those skilled in the relevant art with reference to the remaining text and drawings of this application.

### BRIEF DESCRIPTION OF THE DRAWINGS

FIG. 1A is a perspective, partially-sectioned and -schematicized view of aspects of an exemplary system of the present invention shown in a state of low or moderate tension.

FIG. 1B is a cross-sectional, partially-schematicized view of the aspects of the system of FIG. 1A.

FIG. 2A is a perspective, partially-sectioned and -schematicized view of the aspects of the system of FIG. 1A shown in a state of high tension.

FIG. 2B is a cross-sectional, partially-schematicized view of the aspects of the system of FIG. 1B when in the state of FIG. 2A.

### DETAILED DESCRIPTION

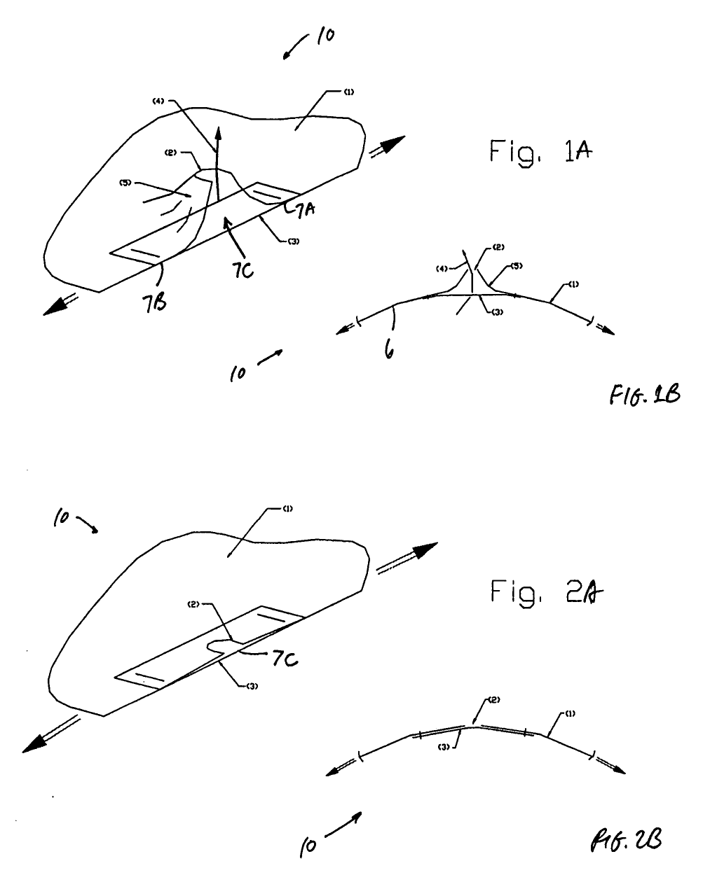

Depicted in FIGS. 1A-2B are aspects of exemplary system 10 of the present invention. System 10 preferably includes an inflatable device 1 and at least one band 3. Inflatable device 1 preferably is a vehicle air bag with a liner or wall having one or more holes 2 therein. Although hole 2 is illustrated as having generally semi-circular cross-section, it may be shaped differently if appropriate or desired.

As shown in FIGS. 1A-2B, band 3 may be substantially rectangular in shape. It too need not necessarily be so shaped, however. Regardless of shape, band 3 is sized (and positioned) so that it may completely cover hole 2 when such covering is desired. Stated differently, if band 3 is generally rectangular and hole 2 is generally circular in shape, the width of band 3 should be at least equal to (and preferably greater than) the diameter of hole 2.

Band 3 additionally advantageously may be elastic or otherwise able to expand and contract based on pressure changes within device 1. Possible materials from which band 3 may be made include (but are not limited to) synthetic or natural rubbers, silicone, or mixtures thereof. Alternatively, band 3 may be made of inelastic material with a fusible element allowing extension under certain pressures.

Band 3 preferably is attached to interior surface 6 of device 1 in alignment with hole 2. Although any suitable attachment mechanism (including gluing, sewing, integral formation with, or otherwise) may be employed to connect band 3 and surface 6, preferably only end portions 7A and 7B of band 3 are attached to the surface 6. This attachment scheme results in central portion 7C of band 3 not being attached to surface 6, thereby permitting central portion 7C to be spaced from hole 2 when desired.

Appropriately attaching band 3 to surface 6 also may create relaxed area or “fold” 5 in the portion of device 1 immediately surrounding hole 2. Fold 5, when present, increases the spacing between band 3 and hole 2. In this respect it may be somewhat analogous to the “pucker” of the Bradburn Publication, although it is present in device 1 itself (rather than in a separate piece of material) and surrounds hole 2 (rather than covering it).

During periods in which device 1 is not under substantial tension, it appears similar to as shown in FIGS. 1A-1B. Such periods may include any of those (a) prior to deployment of device 1 (i.e. when it is uninflated), (b) during deployment of device 1 but prior to the device 1 being impacted by an occupant of a vehicle, (c) during a low- or moderate-energy impact of device 1 by an occupant, or (d) subsequent to deployment of device 1 and impact by an occupant, when the device 1 no longer needs to absorb energy of the occupant. During these periods, fold 5 is present in device 1 and spacing exists between band 3 and hole 2. Because in this situation band 3 is not sealed against hole 2, if gas 4 is present within device 1, some or all of the gas 4 may be vented from the device 1 via the hole 2.

By contrast, device 1 appears as detailed in FIGS. 2A-2B following deployment during a high-energy impact by a vehicle occupant. In this circumstance, occupant-impact forces substantially tension the inflated device 1. These forces eliminate fold 5, thereby abolishing the spacing between hole 2 and band 3 and, effectively, seal the band 3 against the hole 2. This sealing action, in turn, prevents gas from within device 1 venting via hole 2.

Because operation of system 10 is not necessarily binary, the system 10 may assume characteristics intermediate those depicted in FIGS. 1A-1B, on the one hand, and FIGS. 2A-2B, on the other. Occupant impacts on device 1 of intermediate energies may create intermediate tension increases in device 1, progressively reducing spacing between hole 2 and band 3 and thus varying the amount of gas 4 able to be vented. Hence, through varying the amount of gas 4 vented from device 1, the invention effectively may adjust the energy-absorbing capacity of the device 1 without need of advanced crash detection sensors, multi-stage gas generators, or multi-stage or -chambered air bags. Indeed, any suitable crash detection sensors, gas generators, and air bags or similar devices may be utilized in connection with the present invention.

The foregoing is provided for purposes of illustrating, explaining, and describing exemplary embodiments and certain benefits of the present invention. Modifications and adaptations to the illustrated and described embodiments will be apparent to those skilled in the relevant art and may be made without departing from the scope or spirit of the invention. As a non-limiting example of such modifications, band 3 may be pre-weakened in one or more areas (or otherwise constructed) so as to perforate (or otherwise break), and thereby be unable to cover hole 2, when pressure conditions within device 1 might be extremely harmful to the corresponding occupant. Alternatively, extraordinarily high-pressure conditions may cause part of band 3 to protrude through hole 2 so as to allow gas to vent therethrough.

As another non-limiting example, band 3 may itself include a hole, advantageously smaller than but aligned with hole 2, so as to limit the effective size of the hole 2 for venting gas. Also, by this reference the entire contents of both of the Richards Patent and the Bradburn Publication are incorporated herein.

What is claimed is:

1. An inflation system comprising:
a. an inflatable device defining a wall having a vent hole therein, the wall defining an interior surface and comprising a normally relaxed area surrounding the vent hole;
b. a band having a first portion attached to the interior surface of the wall and a second portion aligned with the vent hole so that, when the relaxed area is present, space exists between the band and the vent hole but if the relaxed area is eliminated, the second portion covers the vent hole.

2. An inflation system according to claim 1 in which the band further comprises a third portion attached to the interior surface of the wall, the first and third portions defining end portions of the band and the second portion defining a central portion of the band.

3. An inflation system according to claim 2 in which the end portions of the band are attached to the interior surface of the wall beyond sides of the vent hole.

4. An inflation system according to claim 3 in which the band is elastic.

5. An inflation system according to claim 4 in which (i) the vent hole is generally circular with a diameter, (ii) the band is generally rectangular in shape with a width, and (iii) the width of the band exceeds the diameter of the vent hole.

6. An inflation system according to claim 5 in which the inflatable device is a vehicle air bag.

7. An inflation system according to claim 6 further comprising means for inflating the inflatable device.

8. An inflation system according to claim 7 further comprising a second vent hole in the wall.

9. An inflation system according to claim 1 in which the band is weakened in a selected area so as to perforate and avoid covering the vent hole in certain conditions.

10. A method of deploying an inflatable device comprising:
a. providing the inflatable device with (i) a wall having a vent hole therein, the wall defining an interior surface and comprising a normally relaxed area surrounding the vent hole and (ii) a band having a first portion attached to the interior surface of the wall and a second portion aligned with the vent hole so that space exists between the band and the vent hole; and
b. permitting the inflatable device to be tensioned to eliminate the relaxed area and thereby cover the vent hole with the band.
